(19) United States
(12) Patent Application Publication
(10) Pub. No.: US 2026/0359438 A1
(43) Pub. Date: Nov. 12, 2026

(54) Enhancing system security using neuromorphic processors

(71) Applicant: Bank of America Corporation, Charlotte, NC (US)

(72) Inventors: Adam Kristian King, Fort Mill, SC (US); Alec Trent Tenne, Belmont, NC (US); Nicola Ann Stockton, Chester (GB); James Stefan Corday, Northwich (GB)

(21) Appl. No.: 19/202,361

(22) Filed: May 8, 2025

(51) Int. Cl. G06F 21/56; G06F 21/44; G06F 21/55

(52) U.S. Cl. CPC G06F 21/566; G06F 21/44; G06F 21/554; G06F 2221/033

(57) ABSTRACT

A system includes a memory storing an artificial-intelligence (AI) model and a neuromorphic processor coupled to the memory. The neuromorphic processor receives incoming requests including at least a first incoming request and a second incoming request. The neuromorphic processor detects that the first incoming request includes an authentication tag and executes a task corresponding to the first incoming request. The neuromorphic processor determines that the second incoming request does not comprise an authentication tag. The neuromorphic processor executes the AI model on the second incoming request to detect that the second incoming request includes a malicious software program, identifies a security risk associated with the malicious software program, and mitigates the identified security risk by quarantining the malicious software program in a quarantine sector of the memory.

### TECHNICAL FIELD

The present disclosure relates generally to system security, and more specifically, to enhancing system security using neuromorphic processors.

### BACKGROUND

In cyberattacks, there is a concurrency problem where the outcome of a program’s execution depends on the unpredictable timing or interleaving of multiple threads or processes accessing shared resources, potentially leading to unexpected or incorrect results.

### SUMMARY

Conventional systems rely on traditional timing mechanisms such as clock cycles. For example, conventional systems use system clocks and timeouts, assume operations occur in a sequential order and timing gaps are safe. In addition, conventional systems often lack real-time enforcement mechanisms. However, attackers can leverage the time gaps between the time-separated operations, intervene during the gap (e.g., changing system state, replacing files, altering memory), inject operations or manipulate resources in uncontrolled time window, or delay legitimate processes while sneaking in their malicious processes during these windows. As a result, conventional systems fail to prevent cyberattacks that leverage the situation where the outcome of a process depends on the timing or sequence of events. The drawbacks in the conventional systems lead to the attackers being able to perform malicious operations, including but not limited to, installing or deploying malware, data exfiltration, vulnerabilities targeted attacks, data leakage, network comprise, resource drain, data destruction, and data manipulation, among others. Further, the drawbacks of the conventional system further lead to data stored in some or all the computing devices associated with the system being compromised as the attackers can access that data via the cyber-attacks. For example, sensitive or confidential data, such as personal information and information about operations of an organization can be compromised.

The system disclosed in the present application provides a technical solution to the problems discussed above. The disclosed system uses neuromorphic processors to eliminate the reliance on traditional timing mechanisms by processing incoming requests only when an incoming request has an authentication tag. Neuromorphic processors are event-driven, so they only process incoming requests that are legitimate (i.e., they have authentication tags). Neuromorphic processors would not process incoming requests containing malicious software programs event if these requests are received before the legitimate requests. The disclosed system further quarantines the malicious software program in a quarantine sector of the memory. Therefore, the disclosed system can prevent cyberattacks that leverage the situation where the outcome of a process depends on the timing or sequence of events.

In one embodiment, the disclosed system includes a memory operable to store an artificial-intelligence (AI) model configured to detect malicious software programs in incoming requests. The disclosed system further includes a neuromorphic processor operably coupled to the memory. The neuromorphic processor is configured to receive a plurality of incoming requests comprising at least a first incoming request and a second incoming request. The neuromorphic processor is further configured to detect that the first incoming request comprises an authentication tag. The neuromorphic processor is further configured to execute a task corresponding to the first incoming request. The neuromorphic processor is further configured to determine that the second incoming request does not comprise an authentication tag. The neuromorphic processor is further configured to execute the AI model on the second incoming request to detect that the second incoming request comprises a malicious software program. The neuromorphic processor is further configured to identify a security risk associated with the malicious software program before it executes a malicious software code of the malicious software program on the system. The neuromorphic processor is further configured to mitigate the identified security risk by quarantining the malicious software program in a quarantine sector of the memory before it executes the malicious software code of the malicious software program on the system.

In one embodiment, the first incoming request is associated with an interaction. Executing the task corresponding to the first incoming request includes authorizing the interaction.

In one embodiment, the neuromorphic processor is further configured to partition the memory to generate the quarantine sector of the memory.

In one embodiment, the neuromorphic processor is further configured to, within the quarantine sector of the memory, mitigate the identified security risk by deleting the malicious software code from the malicious software program before the malicious software program executes the malicious software code on the system.

In one embodiment, the neuromorphic processor is further configured to de-partition the quarantine sector of the memory to remove the quarantine sector.

In one embodiment, executing the task corresponding to the first incoming request is triggered by detecting that the first incoming request comprises the authentication tag.

In one embodiment, the second incoming request is received before the first incoming request.

In one embodiment, the second incoming request is received during the execution of the task corresponding to the first incoming request.

The disclosed system and methods provide the practical application of improving network monitoring and detection of malicious requests by using neuromorphic processors which are event-driven and only process incoming requests that are legitimate. Thus, by implementing the disclosed system, the network security and system security are increased. In particular, the network security and system security are increased because the disclosed system uses neuromorphic processors to detect whether incoming requests have authentication tags and process incoming requests only when they have authentication tags. The disclosed system would not process incoming requests containing malicious software programs even if these requests are received before the legitimate requests. The conventional systems would have failed to detect a malicious request leveraging the situation where the outcome of a process depends on the timing or sequence of events because they rely on traditional timing mechanisms. In response to detecting that the incoming request is malicious, the disclosed system quarantines the malicious software program of the incoming request in a quarantine sector and prevents it from being executed. In this manner, the disclosed system prevents cyber-attacks that leverage the situation where the outcome of a process depends on the timing or sequence of events. Further, by implementing the disclosed system, data stored within the systems and devices are secured from malicious network activities of attackers.

Technical advantages of certain embodiments of this disclosure may include one or more of the following. The disclosed system and methods can proactively mitigate malicious incoming requests. Therefore, the disclosed system reduces the probability of malicious activities described above, such as data exfiltration, data destruction, and data manipulation, among others. In particular, reducing the probability of malicious activities leads to technical advantages, such as protecting sensitive data from unauthorized access, which can increase the accuracy and consistency of stored data by preventing unauthorized modifications and can also help against the loss of data due to data exfiltration. Other technical advantages include minimizing system downtime due to cyber-attacks and enabling faster and more effective incident response. These technical advantages lead to additional technical advantages such as enhanced network resilience, increased operational continuity, and faster recovery times. By proactively identifying and addressing potential issues, minimizing system downtime strengthens the overall stability and robustness of the system, reducing the likelihood of unexpected outages due to cyber-attacks. Effective monitoring and rapid response mechanisms allow for quicker restoration of system functionality in case of failures, minimizing the impact of any downtime that does occur due to cyber-attacks. Reduced downtime also helps prevent data loss by ensuring consistent system operation and reducing the risk of corruption during unexpected outages. Monitoring system performance during uptime enables the identification of bottlenecks and potential issues, allowing for proactive optimization and improved overall system efficiency. With a robust system that minimizes downtime, entities can more easily scale operations and adapt to changing demands without significant disruptions.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates one embodiment of a system that is configured for enhancing system security using neuromorphic processors.

FIG. 2 illustrates an example flowchart of a method for enhancing system security using neuromorphic processors.

### DETAILED DESCRIPTION

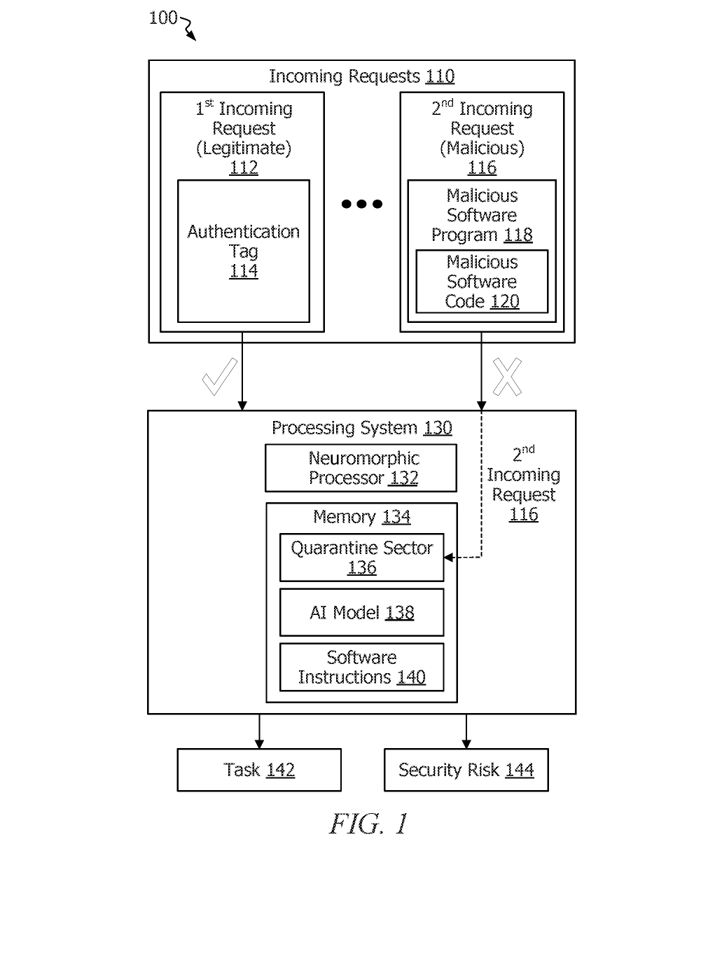

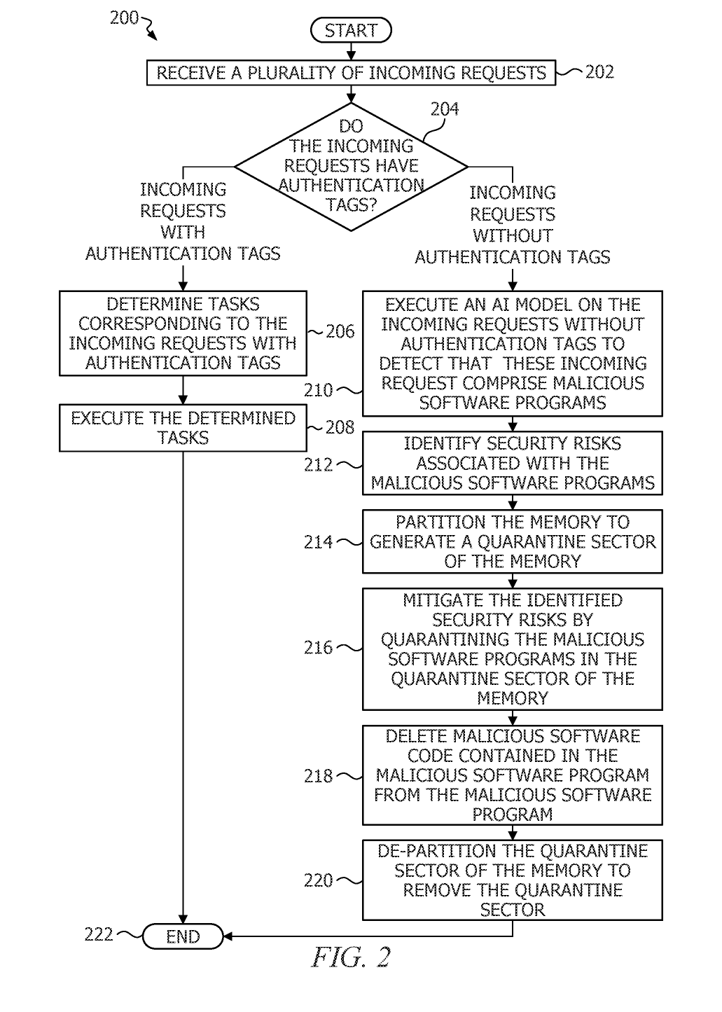

As described above, conventional systems may fail to address the cyberattacks leveraging the situation where the outcome of a process depends on the timing or sequence of events, e.g., malicious code being executed before legitimate processes. This disclosure provides various systems and methods to utilize neuromorphic processors to eliminate the reliance on traditional timing mechanisms by processing incoming requests only when they have authentication tags, preventing the cyberattacks leveraging the situation where the outcome of a process depends on the timing or sequence of events. FIG. 1 illustrates one embodiment of a system that is configured for enhancing system security using neuromorphic processors. FIG. 2 illustrates an example flowchart of a method for enhancing system security using neuromorphic processors.

### Example system for enhancing system security using neuromorphic processors

FIG. 1 illustrates one embodiment of a system 100 that is configured for enhancing system security using neuromorphic processors. System 100 comprises a processing system 130. In some embodiments, system 100 may not have all of the components listed and/or may have other elements instead of, or in addition to, those listed above.

### Architecture components

### Processing system

Processing system 130 is generally any device that is configured to process data and communicate with devices, systems, etc. Processing system 130 is generally configured to perform operations described further below in conjunction with method 200 described in FIG. 2. In an embodiment, processing system 130 comprises one or more neuromorphic processors 132 in signal communication with a memory 134.

Neuromorphic processors 132 are operably coupled to the memory 134. A neuromorphic processor 132 is a specialized type of computing hardware. The processing elements in a neuromorphic processor 132 are artificial neurons and synapses that mimic their biological counterparts. Neurons process and transmit signals (spikes) asynchronously. Synapses store connection weights and update them based on learning rules. Neuromorphic processors 132 implement hardware-based spiking neural networks (SNNs) to perform computations efficiently with lower energy consumption. SNNs use discrete electrical spikes to encode information. Neuromorphic processors 132 operate asynchronously and conduct event-driven computation, meaning neurons only compute when an input spike is received. Neuromorphic processors 132 eliminate the reliance on clock cycles by processing events only when inputs trigger, preventing the cyberattacks leveraging the situation where the outcome of a process depends on the timing or sequence of events.

Neuromorphic processors 132 are implemented using digital logic circuits, analog memristors, or a combination of both. Analog neuromorphic processors 132 use continuous voltage or current signals to emulate neural behavior closely. Digital neuromorphic processors 132 use binary-based signals. Hybrid designs combine the best of both approaches, using analog computation for efficiency and digital control for flexibility. Neuromorphic processors 132 can simulate large-scale neural networks with network-on-chip (NoC) interconnects. NoC-based communication mimics biological connectivity, allowing for efficient spike propagation across the processor.

Neuromorphic processors 132 are configured to implement various software instructions 140. For example, neuromorphic processors 132 are configured to execute software instructions 140 to implement the functions disclosed herein, such as some or all of those described with respect to FIGS. 1-2.

Memory 134 may be volatile or non-volatile and may comprise a read-only memory (ROM), random-access memory (RAM), ternary content-addressable memory (TCAM), dynamic random-access memory (DRAM), and static random-access memory (SRAM). Memory 134 may be implemented using one or more disks, tape drives, solid-state drives, and/or the like. Memory 134 is operable to store the software (e.g., artificial-intelligence (AI) model 138), and/or any other data or software instructions 140. Memory 134 may include a quarantine sector 136. Quarantine sector 136 is a memory sector created by the disclosed system such that software programs, software applications, or any files stored in this quarantine sector 136 are not permitted or prevented from acting on files outside the quarantine sector 136. Thus, any malicious software programs isolated in the quarantine sector 136 cannot harm or attack the rest of the components outside the quarantine sector 136.

AI model 138 can detect malicious software programs in incoming requests. AI model 138 can be trained on a training dataset comprising a plurality of training data using appropriate algorithms. The training data may include legitimate incoming requests having authentication tags and malicious incoming requests containing malicious software programs. Malicious incoming requests do not have authentication tags.

Software instructions 140 may comprise any suitable set of instructions, logic, rules, or code operable to execute neuromorphic processors 132. Software instructions 140, when executed by neuromorphic processors 132, cause neuromorphic processors 132 to perform one or more functions described herein. For example, when software instructions 140 are executed, neuromorphic processors 132 determine whether an incoming request has an authentication tag. If the incoming request has an authentication tag, neuromorphic processors 132 further execute a task corresponding to the incoming request. If the incoming request does not have an authentication tag, neuromorphic processors 132 does not process the incoming request. Neuromorphic processors 132 further execute AI model 138 to detect malicious software program in the incoming request. When software instructions 140 are executed, neuromorphic processors 132 further identity the security risk of the malicious software and mitigate the security risk by quarantining the malicious software program in the quarantine sector 136.

### Operational flow

In an embodiment, processing system 130 may receive a plurality of incoming requests 110. The incoming requests 110 include at least a first incoming request 112 and a second incoming request 116. In an embodiment, the first incoming request 112 is associated with an interaction.

Processing system 130 detects that the first incoming request 112 includes an authentication tag 114. Based on the detected authentication tag 114, processing system 130 determines the first incoming request 112 is legitimate. Consequently, processing system 130 executes a task 142 corresponding to the first incoming request 112. Continuing with the previous example of the first incoming request 112 being associated with an interaction, executing the task 142 corresponding to the first incoming request 112 may include authorizing the interaction. In some scenarios, processing system 130 may further transmit the first incoming request 112 to other secure infrastructure(s) associated with processing system 130.

In an embodiment, the second incoming request 116 is received before the first incoming request 112. In another embodiment, the second incoming request 116 is received during the execution of the task 142 corresponding to the first incoming request 112. For example, during the authorization of the interaction associated with the first incoming request 112, a cyberattack leveraging the situation where the outcome of a process depends on the timing or sequence of events can be hidden in the second incoming request 116.

Processing system 130 detects that the second incoming request 116 does not include an authentication tag. As such, processing system 130 does not process the second incoming request 116. Instead, processing system 130 executes the AI model 138 on the second incoming request 116. The AI model 138 may detect that the second incoming request 116 includes a malicious software program 118.

In an embodiment, processing system 130 identifies a security risk 144 associated with the malicious software program 118 before it executes a malicious software code 120 of the malicious software program 118 on the processing system 130. In another embodiment, processing system 130 may automatically flag the second incoming request 116 for further review, e.g., by a cybersecurity analyst.

In an embodiment, processing system 130 mitigates the identified security risk 144 by quarantining the malicious software program 118 in the quarantine sector 136 before it executes the malicious software code 120 of the malicious software program 118 on the processing system 130. Within the quarantine sector 136, processing system 130 may further mitigate the identified security risk 144 by deleting the malicious software code 120 from the malicious software program 118 before the malicious software program 118 executes the malicious software code 120 on the processing system 130.

In an embodiment, processing system 130 may improve neuromorphic processors’ 132 ability to detect the cyberattacks leveraging the situation where the outcome of a process depends on the timing or sequence of events through continuous learning mechanisms. For example, by continuously monitoring timing relationships between events, neuromorphic processors 132 can be continuously retrained for improved accuracy in detecting anomalies that indicate the cyberattacks leveraging the situation where the outcome of a process depends on the timing or sequence of events. As another example, neuromorphic processors’ 132 learning rule where neuron connections strengthen or weaken based on the timing of events can be leveraged to dynamically adjust neural weights based on detected the cyberattacks leveraging the situation where the outcome of a process depends on the timing or sequence of events, improving future predictions.

### Example methods for enhancing system security using neuromorphic processors

FIG. 2 illustrates an example flowchart of a method 200 for enhancing system security using neuromorphic processors. Modifications, additions, or omissions may be made to method 200. Method 200 may include more, fewer, or other operations. For example, operations may be performed in parallel or in any suitable order. While at times discussed as processing system 130, or components of any of thereof performing operations, any suitable system or components of the system may perform one or more operations of the method 200. For example, one or more operations of method 200 may be implemented, at least in part, in the form of software instructions (e.g., software instructions 140 of FIG. 1), stored on non-transitory, tangible, machine-readable media (e.g., memory 134 of FIG. 1) that when run by one or more processors (e.g., neuromorphic processors 132 of FIG. 1) may cause the one or more processors to perform operations 202-222.

After start, processing system 130 receives a plurality of incoming requests 110 at operation 202. In an embodiment, one incoming request may be associated with an interaction.

At operation 204, processing system 130 determines whether the incoming requests 110 have authentication tags 114. Authentication tags 114 may indicate the corresponding incoming requests 112 are legitimate.

For incoming requests 112 with authentication tags 114, method 200 proceeds to operation 206.

At operation 206, processing system 130 determines tasks 142 corresponding to the incoming requests 112 with authentication tags 114. For example, for an incoming request 112 being associated with an interaction, the task 142 may be to authorize the interaction.

At operation 208, processing system 130 executes the determined tasks 142. Continuing with the previous example of the incoming request 112 being associated with an interaction, executing the task 142 may include authorizing the interaction.

Method 200 then ends at operation 222.

For incoming requests without authentication tags 114, method 200 proceeds to operation 210. Incoming requests without authentication tags 114 may be potentially malicious. In an embodiment, an incoming request without an authentication tag 114 may be received before another incoming request 112 with an authentication tag 114. In another embodiment, an incoming request without an authentication tag 114 may be received during the execution of a task 142 corresponding to another incoming request 112 with an authentication tag 114. For example, during the authorization of a legitimate interaction request, a cyberattack leveraging the situation where the outcome of a process depends on the timing or sequence of events hidden in an incoming request may be attempted.

At operation 210, processing system 130 executes an AI model 138 on the incoming requests without authentication tags 114 to detect that one or more of these incoming requests include malicious software programs 118. AI model 138 can be trained on a training dataset comprising a plurality of training data using appropriate algorithms. The training data may include legitimate incoming requests having authentication tags and malicious incoming requests containing malicious software programs. Malicious incoming requests do not have authentication tags.

At operation 212, processing system 130 identifies security risks 144 associated with the malicious software programs 118. Processing system 130 may identify such security risks 144 before it executes the malicious software code 120 of the malicious software programs 118. In an embodiment, processing system 130 may automatically flag the corresponding incoming request without an authentication tag 114 for further review, e.g., by a cybersecurity analyst.

At operation 214, processing system 130 partitions the memory 134 to generate a quarantine sector 136 of the memory 134. Quarantine sector 136 is a memory sector in which the stored software programs, software applications, or any files are not permitted or prevented from acting on files outside the quarantine sector 136. Thus, any malicious software programs 118 isolated in the quarantine sector 136 cannot harm or attack the rest of the components outside the quarantine sector 136.

At operation 216, processing system 130 mitigates the identified security risks 144 by quarantining the malicious software programs 118 in the quarantine sector 136 of the memory 134 before it executes the malicious software code 120 of the malicious software programs 118 on the processing system 130.

At operation 218, processing system 130 deletes malicious software code 120 contained in the malicious software programs 118 from the malicious software programs 118 to further mitigate the identified security risks 144 before the malicious software programs 118 execute the malicious software code 120 on processing system 130.

At operation 220, processing system 130 de-partitions the quarantine sector 136 of the memory 134 to remove the quarantine sector 136.

Method 200 then ends at operation 222.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “operation for” are explicitly used in the particular claim.

1. A system, comprising:
a memory operable to store:
an artificial-intelligence (AI) model configured to detect malicious software programs in incoming requests; and
a neuromorphic processor, operably coupled to the memory, and configured to:
receive a plurality of incoming requests comprising at least a first incoming request and a second incoming request;
detect that the first incoming request comprises an authentication tag;
execute a task corresponding to the first incoming request;
determine that the second incoming request does not comprise an authentication tag;
execute the AI model on the second incoming request to detect that the second incoming request comprises a malicious software program;
identify a security risk associated with the malicious software program before it executes a malicious software code of the malicious software program on the system; and
mitigate the identified security risk by quarantining the malicious software program in a quarantine sector of the memory before it executes the malicious software code of the malicious software program on the system.

2. The system of claim 1, wherein the first incoming request is associated with an interaction, and wherein executing the task corresponding to the first incoming request comprises authorizing the interaction.

3. The system of claim 1, wherein the neuromorphic processor is further configured to:
partition the memory to generate the quarantine sector of the memory.

4. The system of claim 1, wherein the neuromorphic processor is further configured to:
within the quarantine sector of the memory, mitigate the identified security risk by deleting the malicious software code from the malicious software program before the malicious software program executes the malicious software code on the system.

5. The system of claim 4, wherein the neuromorphic processor is further configured to:
de-partition the quarantine sector of the memory to remove the quarantine sector.

6. The system of claim 1, wherein executing the task corresponding to the first incoming request is triggered by detecting that the first incoming request comprises the authentication tag.

7. The system of claim 1, wherein the second incoming request is received before the first incoming request.

8. The system of claim 1, wherein the second incoming request is received during the execution of the task corresponding to the first incoming request.

9. A method comprising, by a neuromorphic processor:
receiving a plurality of incoming requests comprising at least a first incoming request and a second incoming request;
detecting that the first incoming request comprises an authentication tag;
executing a task corresponding to the first incoming request;
determining that the second incoming request does not comprise an authentication tag;
executing an artificial-intelligence (AI) model on the second incoming request to detect that the second incoming request comprises a malicious software program, wherein the AI model is configured to detect malicious software programs in incoming requests;
identifying a security risk associated with the malicious software program before it executes a malicious software code of the malicious software program on the neuromorphic processor; and
mitigating the identified security risk by quarantining the malicious software program in a quarantine sector of a memory associated with the neuromorphic processor before it executes the malicious software code of the malicious software program on the neuromorphic processor.

10. The method of claim 9, wherein the first incoming request is associated with an interaction, and wherein executing the task corresponding to the first incoming request comprises authorizing the interaction.

11. The method of claim 9, further comprising:
partition the memory to generate the quarantine sector of the memory.

12. The method of claim 9, further comprising:
within the quarantine sector of the memory, mitigating the identified security risk by deleting the malicious software code from the malicious software program before the malicious software program executes the malicious software code on the neuromorphic processor.

13. The method of claim 9, wherein executing the task corresponding to the first incoming request is triggered by detecting that the first incoming request comprises the authentication tag.

14. The method of claim 9, wherein the second incoming request is received before the first incoming request.

15. The method of claim 9, wherein the second incoming request is received during the execution of the task corresponding to the first incoming request.

16. A non-transitory computer-readable medium storing instructions that, when executed by one or more neuromorphic processors of a system, cause the one or more neuromorphic processors to:
receive a plurality of incoming requests comprising at least a first incoming request and a second incoming request;
detect that the first incoming request comprises an authentication tag;
execute a task corresponding to the first incoming request;
determine that the second incoming request does not comprise an authentication tag;
execute an artificial-intelligence (AI) model on the second incoming request to detect that the second incoming request comprises a malicious software program, wherein the AI model is configured to detect malicious software programs in incoming requests;
identify a security risk associated with the malicious software program before it executes a malicious software code of the malicious software program on the system; and
mitigate the identified security risk by quarantining the malicious software program in a quarantine sector of a memory associated with the system before it executes the malicious software code of the malicious software program on the system.

17. The non-transitory computer-readable medium of claim 16, wherein the first incoming request is associated with an interaction, and wherein executing the task corresponding to the first incoming request comprises authorizing the interaction.

18. The non-transitory computer-readable medium of claim 16, wherein the instructions further cause the one or more neuromorphic processors to:
partition the memory to generate the quarantine sector of the memory.

19. The non-transitory computer-readable medium of claim 16, wherein the instructions further cause the one or more neuromorphic processors to:
within the quarantine sector of the memory, mitigate the identified security risk by deleting the malicious software code from the malicious software program before the malicious software program executes the malicious software code on the system.

20. The non-transitory computer-readable medium of claim 16, wherein executing the task corresponding to the first incoming request is triggered by detecting that the first incoming request comprises the authentication tag.
